(19) United States
(12) Patent Application Publication
(10) Pub. No.: US 2021/0279490 A1
(43) Pub. Date: Sep. 9, 2021

(54) INFORMATION PROCESSING APPARATUS, INFORMATION PROCESSING METHOD, AND SYSTEM

(71) Applicant: TOYOTA JIDOSHA KABUSHIKI KAISHA, Toyota-shi (JP)

(72) Inventors: Yuko MIZUNO, Nagoya-shi (JP); Misa Ejiri, Nagoya-shi (JP); Kazuyuki Kagawa, Nisshin-shi (JP); Yuta Oshiro, Nigoya-shi (JP); Katsuhito Kito, Kasugai-shi (JP)

(73) Assignee: TOYOTA JIDOSHA KABUSHIKI KAISHA, Toyota-shi (JP)

(21) Appl. No.: 17/123,805

(22) Filed: Dec. 16, 2020

(30) Foreign Application Priority Data
Mar. 5, 2020 (JP) 2020-037951

(51) Int. Cl. G06K 9/00; G06K 9/68; G06K 9/20

(52) U.S. Cl. CPC G06K 9/00832; G06K 9/2054; G06K 9/6857

(57) ABSTRACT

A control unit of a server device, which is an information processing apparatus of the present disclosure, acquires an image captured by a fixed camera, acquires, from an in-vehicle camera, an image of a region associated with an image-capturing area of the fixed camera, and adjusts, in a predetermined case, a resolution of the acquired image of the associated area.

### CROSS-REFERENCE TO RELATED APPLICATION

This application claims priority to Japanese Patent Application No. 2020-037951 filed on Mar. 5, 2020, incorporated herein by reference in its entirety.

### BACKGROUND

### 1. Technical Field

The present disclosure relates to an information processing apparatus, an information processing method, and a system.

### 2. Description of Related Art

It has been proposed, for example, to combine cameras outside respective homes to a surveillance system for managing the area (refer to Japanese Unexamined Patent Application Publication No. 2008-299761).

### SUMMARY

The present disclosure provides an apparatus, method, and system which enables capturing of an image of a wider area in order to further enhance an ability to monitor a target area.

One aspect of an embodiment of the present disclosure is implemented by an information processing apparatus including a control unit. The control unit is configured to acquire an image captured by a fixed camera, acquire, from an in-vehicle camera, an image of an area associated with an image-capturing area of the fixed camera, and adjust, in a predetermined case, a resolution of the acquired image of the associated area. Another aspect of the embodiment of the present disclosure is implemented by an information processing method executed by at least one computer such as the information processing apparatus. Another aspect of the embodiment of the present disclosure is also implemented by a system equipped with at least one computer such as an information processing apparatus.

With the information processing apparatus, it is possible to capture an image of a wider area.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a system according to a first embodiment of the present disclosure;

FIG. 2 is a conceptual diagram of the system according to the first embodiment of the present disclosure;

FIG. 3 is a block diagram schematically illustrating a configuration of the system of FIG. 2, particularly illustrating a configuration of an in-vehicle unit;

FIG. 4 is a block diagram schematically illustrating a configuration of the system of FIG. 2, particularly illustrating a configuration of a server device;

FIG. 5 is a diagram illustrating a flowchart of control provided by a control unit of the in-vehicle unit in association with a flowchart of control provided by a control unit of the server device, in the system of FIG. 2;

FIG. 6 is a flowchart of another control provided by the control unit of the in-vehicle unit in the system of FIG. 2;

FIG. 7 is a flowchart of control provided by the control unit of the server device in the system of FIG. 2;

FIG. 8A is a diagram illustrating the process of FIG. 7;

FIG. 8B is a diagram illustrating the process of FIG. 7;

FIG. 8C is a diagram illustrating the process of FIG. 7;

FIG. 9 is a flowchart of another control provided by the control unit of the server device in the system of FIG. 2;

FIG. 10 is a flowchart of another control provided by the control unit of the server device in the system of FIG. 2;

FIG. 11 is a block diagram schematically illustrating a configuration of a system according to a second embodiment of the present disclosure, particularly illustrating a configuration of an in-vehicle unit;

FIG. 12 is a block diagram schematically illustrating a configuration of the system of FIG. 11, particularly illustrating a configuration of a server device; and

FIG. 13 is a flowchart of control provided by the control unit of the server device of FIG. 12.

### DETAILED DESCRIPTION OF EMBODIMENTS

An information processing apparatus including a control unit is exemplified by the present embodiment. The control unit executes acquiring an image captured by a fixed camera, and acquiring an image of an area associated with an image-capturing area of the fixed camera from an in-vehicle camera. The control unit further executes adjusting, in a predetermined case, a resolution of the acquired image, which is captured by the in-vehicle camera.

The control unit of the information processing apparatus may acquire, for example, an image captured by a fixed camera installed on a roadside or a building. On the other hand, the control unit of the information processing apparatus acquires an image captured by an in-vehicle camera before, after, or at the same time as the image captured by the fixed camera is acquired. The in-vehicle camera is capable of capturing an image of an area associated with the image-capturing area of the fixed camera. The in-vehicle camera is expected to capture a blind spot (blind spot area) of the fixed cameras, the blind spot being, for example, a parking lot of the building (including a garage) or the roadside.

The image captured by the in-vehicle camera is preferably stored at a relatively low resolution during normal times. The resolution can be set optionally, and may be, for example, a level at which a face of a person who is captured cannot be easily identified so as to protect privacy. In the predetermined case, for example, when a predetermined external stimulus is detected, the image captured by the in-vehicle camera is preferably stored at a relatively high resolution and used in monitoring so as to, for example, crime prevention. Adjusting the resolution of the image captured by the in-vehicle camera includes adjusting at least one of a resolution of the in-vehicle camera when capturing the image and a resolution of the image captured by the in-vehicle camera. Accordingly, the information processing apparatus can provide excellent monitoring ability with a high resolution image in the predetermined case while, for example, protecting privacy. On the other hand, according to the information processing apparatus, the image captured by the fixed camera and the image captured by the in-vehicle camera are used, thus it is possible to capture an image of a wider area as compared with a case where only the image captured by the fixed camera is used, thereby further enhancing the ability to monitor the target area.

Hereinafter, an information processing apparatus according to an embodiment of the present disclosure, an information processing method in a control unit of the information processing apparatus, and a system including the information processing apparatus will be described referring to drawings.

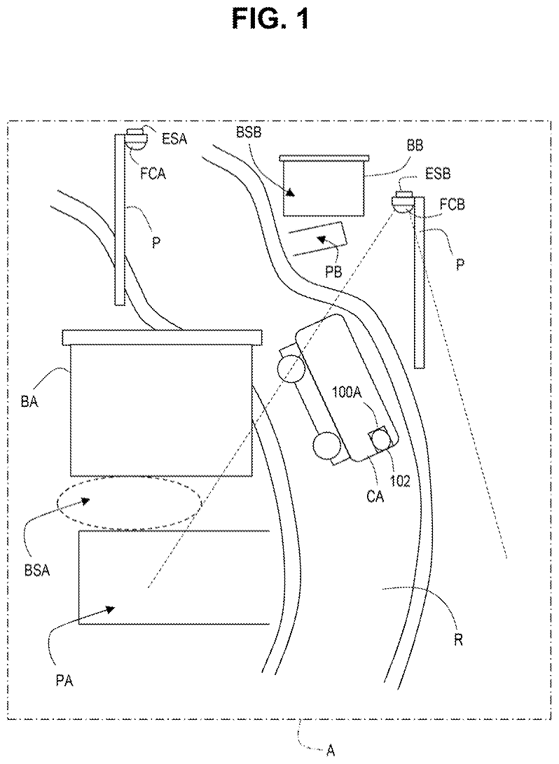

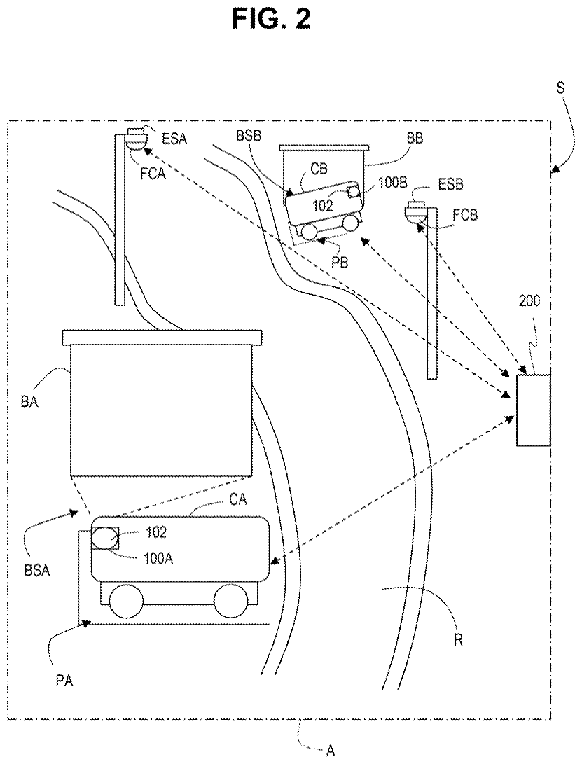

A system S according to a first embodiment of the present disclosure will be described referring to FIGS. 1 and 2. As shown in FIG. 1, several fixed cameras FC (FCA, FCB, . . . ) are arranged along a road R. The system S can monitor a target area A as shown in FIG. 1 based on the images acquired from those fixed cameras FC.

However, there is a blind spot that cannot be covered by only the fixed cameras FC. For example, as shown in FIGS. 1 and 2, two fixed cameras FCA and FCB cannot acquire images of a shadow BSA of a building BA, and a shadow BSB of a vehicle between a building BB and a parking lot PB next to the building BB when the vehicle is parked in the parking lot PB. Hence, the monitoring capability is limited when using only the images captured by the fixed cameras FC. Therefore, as shown in FIG. 2, the system S uses an image captured by an in-vehicle camera 102 of an in-vehicle unit 100 (100A, 100B, . . . ) mounted on a vehicle C (CA, CB, . . . ), together with the images captured by the fixed cameras FC, in order to cover such a blind spot. This configuration improves the monitoring capability. That is, the in-vehicle camera 102 of the in-vehicle unit 100A or 100B is capable of capturing an image of an area associated with an image-capturing area of the fixed camera FCA or FCB, for example, the blind spot or the shadows BSA and BSB.

As shown in FIG. 2, the system S includes a server device 200 that cooperates with the fixed camera FC and the in-vehicle camera 102. The server device 200 is the information processing apparatus, and acquires and processes the image captured by the fixed camera FC and the image captured by the in-vehicle camera 102, respectively. There is a plurality of fixed cameras FC in the system S, two in FIGS. 1 and 2. However, the number of fixed cameras is not limited thereto and may be one. Further, there is a plurality of in-vehicle cameras 102 in the system S, two in FIG. 2. However, the number of in-vehicle cameras is not limited thereto and may be one.

The fixed camera FC is arranged along the road R as stated above, and is also arranged on a pole P standing upright along the road R. However, the fixed camera FC may be provided in various buildings such as private homes and buildings. The fixed camera FC has a function of capturing an image of a predetermined area and transmitting the captured image. In the present embodiment, the fixed camera FC has a communication unit similar to a communication unit 112 described hereinbelow, and transmits the captured image to the server device 200. The fixed camera FC is usually in an on state and transmits the images captured at predetermined time intervals. Although the image captured by the fixed camera FC and transmitted to the server device 200 is a still image in the present embodiment, it may be a moving image. Further, as data, a timing at which the image is captured and identification information (for example, ID) as information indicating the fixed camera which is used for capturing the image are attached to the image transmitted from the fixed camera FC. The information attached to the image is not limited to the pieces of data stated above, and may include, for example, information on the resolution of the fixed camera FC. In this case, the resolution of the fixed camera FC may be adjustable.

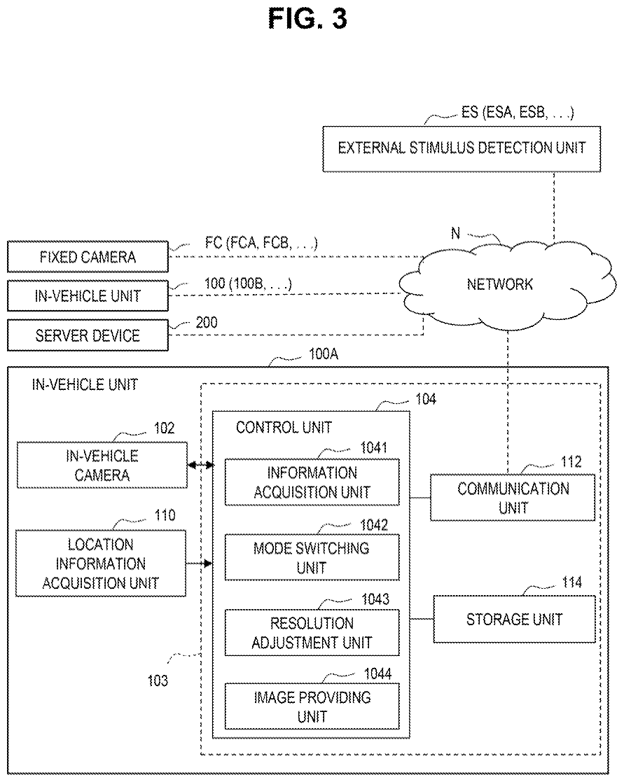

The in-vehicle camera 102 is a camera that can be moved, unlike a fixed camera. The in-vehicle unit 100 including the in-vehicle camera 102 will be described referring to FIG. 3. The in-vehicle units 100 are provided in various vehicles C, and may respectively have the same configuration or different configurations. Hereinbelow, a case where the in-vehicle units 100 share the same configuration will be described.

FIG. 3 is a block diagram schematically illustrating a configuration of the system S, and in particular, a configuration of the in-vehicle unit 100A mounted on a vehicle CA, which is positioned in the system S. FIG. 3 shows the configuration of the in-vehicle unit 100A as one example of the in-vehicle unit 100. The other in-vehicle units 100 (100B, . . . ) have the same configuration as described below.

The in-vehicle unit 100A is a device that is added to the vehicle CA after manufacturing. It may be incorporated in the manufacturing process of the vehicle CA. Further, the in-vehicle unit 100A may be or may include, for example, a part of the information processing apparatus in the vehicle CA as a traveling unit which is one type of an autonomous vehicle and is also called an electric vehicle (EV) pallet. The vehicle CA provided with the in-vehicle unit 100A may be a vehicle including an internal combustion engine as a power source, or may be a vehicle having no automatic driving function.

The in-vehicle unit 100A shown in FIG. 3 is provided with an information processing apparatus 103, and includes a control unit 104 that substantially performs functions thereof The in-vehicle unit 100A can communicate with the server device 200, operates in response to a command transmitted from the server device 200, and provides the image to the server device 200.

The in-vehicle unit 100A is configured to include a location information acquisition unit 110, a communication unit 112, and a storage unit 114, in addition to the in-vehicle camera 102 and the control unit 104. The in-vehicle unit 100A operates with electric power supplied from a battery of the vehicle CA.

For example, the in-vehicle camera 102 may be an image capturing device using an image sensor such as charged-coupled devices (CCD), metal-oxide-semiconductor (MOS), or complementary metal-oxide-semiconductor (CMOS). Although the in-vehicle camera 102 is provided at a front side or a rear side of the vehicle CA as shown in FIG. 1, the number of the in-vehicle cameras 102 may be any number, which may be one or more. The in-vehicle camera 102 is configured such that its resolution is variable when it is used for capturing the image. The resolution of the in-vehicle camera 102 can be switched between two modes, a relatively low resolution (hereinafter referred to as “low resolution”) and a resolution higher than the low resolution (hereinafter referred to as “high resolution”). The resolution of the in-vehicle camera 102 may be switched between three modes or more.

The location information acquisition unit 110 is a unit that acquires the current location of the in-vehicle unit 100A, i.e., the vehicle CA. The location information acquisition unit 110 may be configured to include a GPS (Global Positioning System) receiver. A GPS receiver, as a satellite signal receiver, receives signals from a plurality of GPS satellites. Each GPS satellite is an artificial satellite that orbits the earth. A satellite navigational system, i.e., navigation satellite system (NSS), is not limited to the GPS. The location information may be detected based on signals from various satellite navigational systems. The NSS is not limited to the global navigation satellite system, but may include the Quasi-Zenith Satellite System, such as “Galileo” in Europe or “Michibiki” in Japan, which is integrated with the GPS. The location information acquisition unit 110 may include a receiver such as a beacon that receives radio waves from a transmitter. In this case, several transmitters are arranged in a predetermined area associated with the vehicle CA, such as a predetermined line of a parking lot PA and a side thereof in this specification, and regularly emit radio waves of a specific frequency and/or signal format. Moreover, a location information detection system including the location information acquisition unit 110 is not limited thereto.

The control unit 104 is a device, i.e., a computer, that is electrically connected to, for example, the in-vehicle camera 102 and the location information acquisition unit 110. The control unit 104 includes a CPU and a main storage unit, and executes information processing by a program. The CPU is also called a processor. The main storage unit of the control unit 104 is one example of a main storage device. The CPU in the control unit 104 executes a computer program that is deployed in the main storage unit so as to be executable, and provides various functions. The main storage unit in the control unit 104 stores computer programs executed by the CPU and/or data. The main storage unit in the control unit 104 is a dynamic random access memory (DRAM), a static random access memory (SRAM), a read only memory (ROM), or the like.

The control unit 104 is connected to the storage unit 114. The storage unit 114 is a so-called external storage unit, which is used as a storage area that assists the main storage unit of the control unit 104, and stores computer programs executed by the CPU of the control unit 104, and/or data. The storage unit 114 is a hard disk drive, a solid state drive (SSD), or the like.

The control unit 104 includes, as functional modules, an information acquisition unit 1041, a mode switching unit 1042, a resolution adjustment unit 1043, and an image providing unit 1044. Each functional module is implemented by executing a program stored in the main storage unit and/or the storage unit 114 by the control unit 104, that is, the CPU.

The information acquisition unit 1041 acquires information on, for example, the command from the server device 200. As will be described later, the server device 200 can provide the in-vehicle unit 100A with a command for changing the resolution of the in-vehicle camera 102.

The mode switching unit 1042 switches the resolution mode based on the command provided by the server device 200. This resolution mode can be switched such that the resolution of the in-vehicle camera 102 can be switched between the high resolution and the low resolution. In the present embodiment, the resolution can be switched between the high resolution and the low resolution, thus there are two resolution modes. One mode is a high resolution mode and the other mode is a low resolution mode.

The resolution adjustment unit 1043 adjusts the resolution of the in-vehicle camera 102 when capturing the image according to the mode switched by the mode switching unit 1042. When switched to the high resolution mode, the resolution of the in-vehicle camera 102 is adjusted to the high resolution, and when switched to the low resolution mode, the resolution of the in-vehicle camera 102 is adjusted to the low resolution.

The image providing unit 1044 provides the image captured by the in-vehicle camera 102 by transmitting the image to the server device 200. In the present embodiment, the image providing unit 1044 transmits a location of the in-vehicle camera 102, specifically location information of the in-vehicle unit 100A, to the server device 200. This location information is location information acquired by the location information acquisition unit 110, and may be location information on a predetermined area. When the location information acquired by the location information acquisition unit 110 indicates a location within the predetermined area, the image providing unit 1044 captures the image with the in-vehicle camera 102 and transmits the image to the server device 200. For the in-vehicle unit 100A, the predetermined area is the parking lot PA. In a case where the image is transmitted, a timing at which the image is captured by the in-vehicle camera 102, and identification information (for example, ID) of the in-vehicle camera 102 of the in-vehicle unit 100A as information indicating the in-vehicle camera 102 of the in-vehicle unit 100A which is used for capturing the image are attached to the transmitted image, as data. The information attached to the image is not limited to the timing at which the image is captured and the identification information. For example, the information attached to the image may include information on the resolution and/or location information.

The communication unit 112 has a communication unit configured to allow the in-vehicle unit 100A to access the network N. In the first embodiment, the in-vehicle unit 100A can communicate with other devices (for example, the server device 200) via the network N.

The server device 200 in the system S will be described.

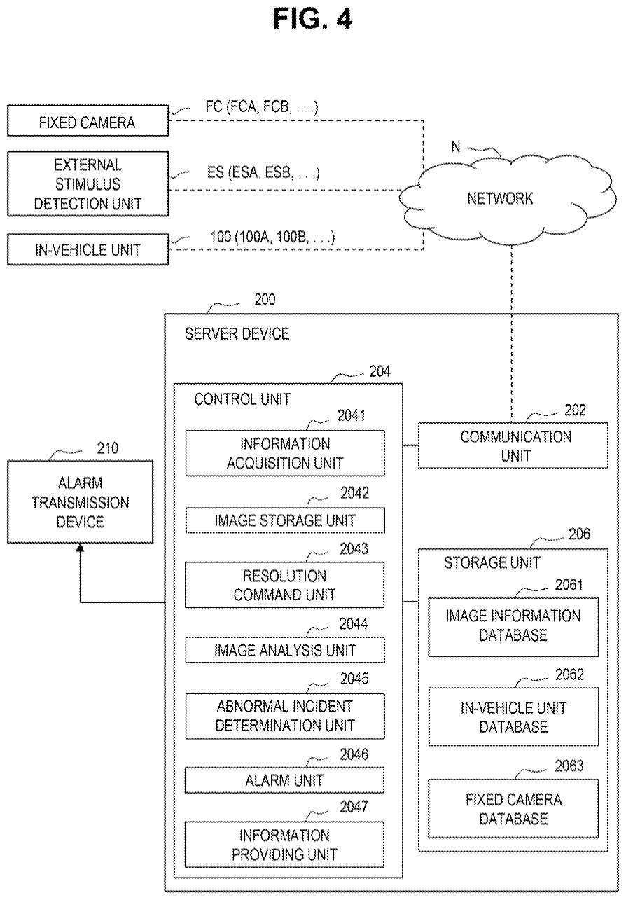

The server device 200 is, as stated above, the information processing apparatus, and includes a communication unit 202, a control unit 204, and a storage unit 206, as shown in FIG. 4. The communication unit 202 is the same as the communication unit 112 and has a communication function for connecting the server device 200 to the network N. The communication unit 202 of the server device 200 is a communication interface for communicating with the in-vehicle unit 100 via the network N. The control unit 204 includes a CPU and a main storage unit, and executes information processing by a program, similar to the control unit 104. This CPU is also a processor, and the main storage unit of the control unit 204 is also one example of a main storage device. The CPU in the control unit 204 executes a computer program that is deployed in the main storage unit so as to be executable, and provides various functions. The main storage unit in the control unit 204 stores computer programs executed by the CPU and/or data. The main storage unit in the control unit 204 is a DRAM, SRAM, ROM, or the like.

The control unit 204 is connected to the storage unit 206. The storage unit 206 is an external storage unit, which is used as a storage area that assists the main storage unit of the control unit 204, and stores computer programs executed by the CPU of the control unit 204, and/or data. The storage unit 206 is a hard disk drive, an SSD, or the like.

The control unit 204 is a unit configured to control the server device 200. As illustrated in FIG. 4, the control unit 204 includes, as functional modules, an information acquisition unit 2041, an image storage unit 2042, a resolution command unit 2043, an image analysis unit 2044, an abnormal incident determination unit 2045, an alarm unit 2046, and information providing unit 2047. Each of these functional modules is implemented by executing a program stored in the main storage unit and/or the storage unit 206 by the CPU of the control unit 204.

The information acquisition unit 2041 acquires various types of information (for example, the captured image) from the in-vehicle unit 100 having the in-vehicle camera 102, the fixed camera FC, and the like. The information acquisition unit 2041 transmits, when acquiring the image, the image to the image storage unit 2042.

The image storage unit 2042 stores the image captured by the fixed camera FC in an image information database 2061 of the storage unit 206 in association with the image captured by the in-vehicle camera 102. These images are associated such that images that were captured at the same time/timing or were captured at different times/timings but the differences falls within a predetermined range are associated with each other. That is, the images captured at substantially the same time are associated as images captured at the same time. Therefore, the image captured by the in-vehicle camera 102 of the in-vehicle unit 100 is attached to the information on the timing at which the image is captured as described above. The information on the timing at which the image is captured is also attached to the image captured by the fixed camera FC. The associated images may be optionally combined, for example, the image of the fixed camera FC may be combined with the image of another fixed camera FC, the image of the in-vehicle camera 102 may be combined with the image of another in-vehicle camera 102, the image of the fixed camera FC may be combined with the image of the in-vehicle camera 102. The images associated with each other are not limited to two and may be three or more.

The resolution command unit 2043 generates a command for one or more in-vehicle units 100 to designate the resolution of the in-vehicle camera 102 mounted therein, and transmits the command to the in-vehicle unit 100, that is, the in-vehicle camera 102. In the present embodiment, as stated above, the resolution of the image captured by the in-vehicle camera 102 of the in-vehicle unit 100 can be the high resolution and the low resolution. The current resolution of the in-vehicle camera 102 of the in-vehicle unit 100 is stored in an in-vehicle unit database 2062 of the storage unit 206 in association with the identification information of the in-vehicle unit 100. Therefore, the command for designating the resolution in the resolution command unit 2043 is a command for changing the resolution of the in-vehicle camera 102 to a resolution different from the current resolution. The resolution command unit 2043 is operated by acquiring detected information on the external stimulus, which is acquired from an external stimulus detection unit ES. The resolution command unit 2043 updates, when transmitting the command, the in-vehicle unit database 2062 such that the resolution of the in-vehicle unit 100 at a transmission destination can be the resolution according to the command. The resolution command unit 2043 selects the in-vehicle camera 102 of which a resolution is to be adjusted in a predetermined case according to an available capacity of the storage unit 206 that stores the image captured by the fixed camera FC and the image captured by the in-vehicle camera 102. The predetermined case may be, for example, a case where a predetermined external stimulus is acquired.

The image analysis unit 2044 analyzes the image stored in the image information database 2061 of the storage unit 206 and extracts, for example, unique information. This process is executed for both the image acquired from the in-vehicle camera 102 of the in-vehicle unit 100 and the image acquired from the fixed camera FC.

The abnormal incident determination unit 2045 determines whether or not an abnormal incident occurs based on the information extracted by the image analysis unit 2044. In the present embodiment, the abnormal incident determination unit 2045 determines whether or not the extracted information matches with one of abnormality patterns stored in the storage unit 206. The abnormality pattern can be variously set from the viewpoints of crime prevention, disaster prevention, and/or prevention of wandering elderly persons. For example, one of the abnormality patterns corresponds to an image of a person lying on a road. The process of the abnormal incident determination unit 2045 may be replaced by other processes, for example, an incident determination process executed by artificial intelligence (AI).

The alarm unit 2046 issues an alarm when the abnormal incident determination unit 2045 determines that an abnormal incident has occurs. In the present embodiment, the server device 200 activates an alarm transmission device 210 connected thereto such that the alarm transmission device 210 emits an alarm, for example, a siren sound. The alarm transmission device 210 is a speaker that emits predetermined sound in the present embodiment. The alarm transmission device 210 may emit sound according to, for example, a type of the determined abnormal incident. Further, the number of alarm transmission devices 210 is not limited to one, and may be provided for each of sub-areas in the target area A.

The information providing unit 2047 transmits or provides various information, for example, by transmitting the command from the resolution command unit 2043 to the in-vehicle unit 100. The information providing unit 2047 can refer to contact information of the in-vehicle unit 100 stored in the in-vehicle unit database 2062 and transmit such information.

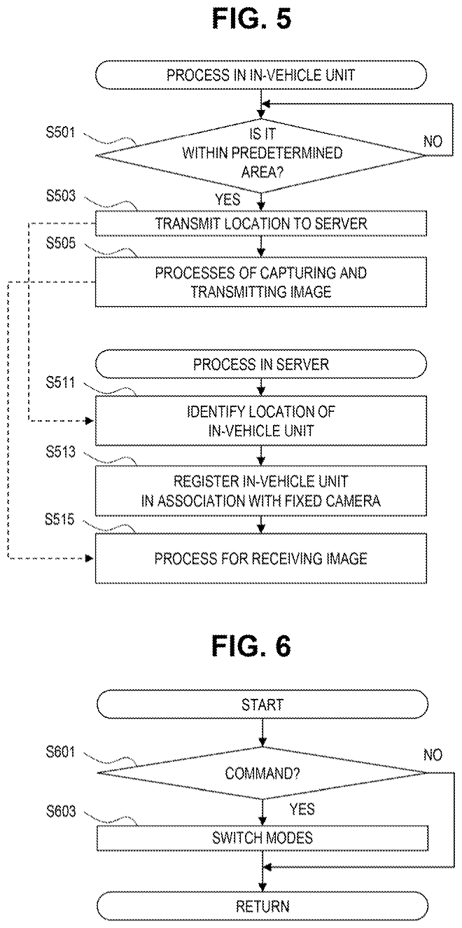

Various processes in the system S having the configuration stated above will be described. How to capture and transmit the image by the in-vehicle camera 102 in the in-vehicle unit 100 will be described referring to FIGS. 1, 2 and 5. In the present embodiment, the process of the in-vehicle unit 100A, from among the in-vehicle units 100, will be described, but the same can be applied to the processes of the other in-vehicle units 100 (100B, . . . ). In FIG. 5, the in-vehicle unit 100 and the server device 200 cooperate to execute the process, the two flowcharts are connected by a dotted line to illustrate the cooperative processes.

The image providing unit 1044 in the control unit 104 of the in-vehicle unit 100A determines whether or not the current location acquired by the location information acquisition unit 110 is within the predetermined area (step S501). In the present embodiment, the predetermined area is the parking lot PA of the vehicle CA equipped with the in-vehicle unit 100A. Therefore, as shown in FIG. 1, when the vehicle CA is traveling on the road R, it is determined as “NO” in step S501. On the other hand, as shown in FIG. 2, when the vehicle CA reaches the parking lot PA and is located within the predetermined area, it is determined as “YES” in step S501.

When the vehicle CA reaches the parking lot PA and is parked in a parking space (“YES” in step S501), the image providing unit 1044 of the control unit 104 in the in-vehicle unit 100A transmits the location information so as to register the location in the server device 200 (step S503). For example, the location information acquisition unit 110 of the in-vehicle unit 100A may acquire the current location, and the control unit 104 may notify the server device 200 of the current location.

The information acquisition unit 2041 of the control unit 204 in the server device 200 receives notification of the current location of the in-vehicle unit 100A and identifies the current location of the in-vehicle unit 100A (step S511). The server device 200 registers the in-vehicle unit 100A in association with the fixed camera FC (step S513). For example, the server device 200 may have fixed cameras FC respectively installed at each of locations (or locations of which a visual axis reaches a parking surface of the parking lot PA). The location where the fixed camera is installed can be defined by, for example, latitude and longitude. The server device 200 stores, in the in-vehicle unit database 2062 of the storage unit 206, the information for identifying the in-vehicle unit 100A of the vehicle CA parked within a predetermined distance from the location at which each of fixed cameras FC is installed (or location of its visual axis on the parking surface).

The information for identifying the in-vehicle unit 100A is, for example, an address of the communication unit 112 of the in-vehicle unit 100A on the network. A process of step S513 is one example of a case where the fixed camera FC is associated with the in-vehicle camera 102 when the vehicle CA equipped with the in-vehicle camera 102 is parked at the predetermined location with respect to the fixed camera FC.

However, the server device 200 may associate the in-vehicle cameras or the in-vehicle units of all vehicles stored in the parking lot PA with each of fixed cameras FC in the parking lot PA.

Instead of such a process, the server device 200 may specify a parking location of the vehicle CA, that is, a location of the in-vehicle unit 100A based on the image from the fixed camera FC of the parking lot PA. Alternatively, a sensor may be provided for each parking space, and the server device 200 may identify a location based on a signal from the sensor. Consequently, the server device 200 stores the identification information of the in-vehicle unit 100A in the storage unit 206 together with the location of the in-vehicle unit 100A. That is, the server device 200 is in a state of being able to receive the image from the in-vehicle unit 100A while it is determined in which parking space the vehicle CA equipped with the in-vehicle unit 100A is parked.

Furthermore, the server device 200 may have a map that defines the location of the fixed camera FC in the parking lot PA, a range covered by an angle of view of the fixed camera FC, and a location that is hidden in a shadow within the range covered by the angle of view of the fixed camera FC. The fixed camera FC is preferably associated with the in-vehicle camera, as the in-vehicle camera that transmits a high-priority image of the in-vehicle unit provided in the vehicle which is parked at a location adjacent to the location that is hidden in a shadow within the range covered by the angle of view of the fixed camera FC.

The image providing unit 1044 of the control unit 104 in the in-vehicle unit 100A activates the in-vehicle camera 102 and transmits, as data, the image captured by the in-vehicle camera 102 to the server device 200 (step S505). This process is repeated until the vehicle CA leaves the parking lot PA. The image may be transmitted at a predetermined interval for a predetermined period. For example, every few minutes, the image may be transmitted for one minute. In a case where the image is a moving image, a standard value is adopted as the frame rate. However, the frame rate may be lower than usual before the external stimulus described below occurs.

Consequently, the server device 200 receives the image from the in-vehicle unit 100A (step S515). The received image is associated with the image transmitted from the fixed camera FC related to the location of the in-vehicle unit 100A. This process ends when the vehicle CA leaves the parking space. At this time, the server device 200 clears the registration of the in-vehicle unit 100A associated with the fixed camera FC.

Consequently, the image captured by the in-vehicle camera 102 of each in-vehicle unit 100 is provided to the server device 200 and acquired by the server device 200. As described above, the timing at which the image is captured and the identification information of the in-vehicle unit 100 are attached to the provided image.

A resolution switching process for the in-vehicle camera 102 of the in-vehicle unit 100 will be described referring to FIG. 6.

When the information acquisition unit 1041 of the control unit 104 in the in-vehicle unit 100A acquires a command for switching resolution from the server device 200 (“YES” in step S601), the information acquisition unit 1041 transmits an activation signal to the mode switching unit 1042. Further, when the command for switching resolution is acquired from the server device 200 (“NO” in step S601), the activation signal is not transmitted to the mode switching unit 1042, and the resolution of the in-vehicle camera 102 set at that time is maintained.

When activated, the mode switching unit 1042 switches the resolution mode (step S603). The modes that can be switched include a high resolution mode and a low resolution mode. When the high resolution mode is already set, the resolution mode is switched to the low resolution mode. When the low resolution mode is already set, the resolution mode is switched to the high resolution mode. Accordingly, the resolution of the image captured by the in-vehicle camera 102, i.e., data, changes.

Moreover, the images captured by each of the fixed cameras FC are transmitted to the server device 200 constantly or during a period in which predetermined intervals are repeated. The identification information of the fixed camera FC and the timing at which the image is captured are also attached to the image of the fixed camera FC thus acquired by the server device 200.

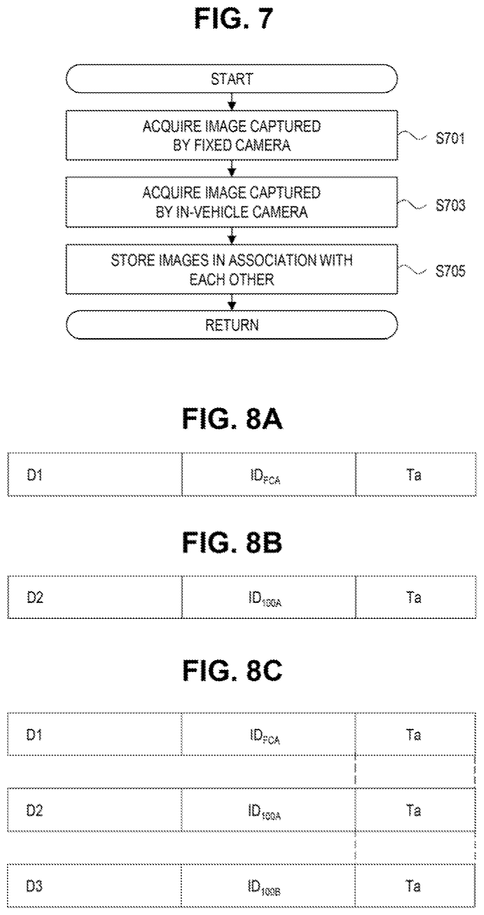

Next, a process executed in the server device 200 will be described. A process of storing the acquired image in the server device 200 will be described referring to FIGS. 7, 8A, 8B, and 8C. Hereinbelow, a case where, for example, an image D1 captured by the fixed camera FCA is stored in association with an image D2 captured by the in-vehicle camera 102 of the in-vehicle unit 100A.

When the information acquisition unit 2041 of the control unit 204 in the server device 200 acquires the image D1 captured by the fixed camera FCA (step S701), the information acquisition unit 2041 transmits the image D1 to the image storage unit 2042. Moreover, when the information acquisition unit 2041 of the control unit 204 in the server device 200 acquires the image D2 captured by the in-vehicle camera 102 within the parking space associated with the fixed camera FC as described above (step S703), the image D2 is transmitted to the image storage unit 2042. In the present embodiment, the in-vehicle unit 100A is registered in association with the fixed camera FC by means of the process of step S513, thus the image D2 captured by the in-vehicle camera 102 can be one example of the image of the area associated with the image-capturing area of the fixed camera FC. In FIG. 7, after the image D1 captured by the fixed camera FCA is acquired (step S701), the image D2 captured by the in-vehicle camera 102 is acquired (step S703). However, the order is not limited thereto. This order may be reversed or the processes may be simultaneously executed.

The image storage unit 2042 of the control unit 204 in the server device 200 stores the image D1 captured by the fixed camera FCA in association with the image D2 captured by the in-vehicle camera 102 (step S705). This association is performed here based on the timing at which the image is captured. A process of step S705 is one example of a case where the image captured by the fixed camera FC is stored in association with the image of the associated area, which is captured by the in-vehicle camera 102.

The image D1 captured by the fixed camera FCA is conceptually shown in FIG. 8A. The image D1 captured by the fixed camera FCA is attached with identification information “ID_{FCA}” of the fixed camera FCA and a timing “Ta” at which the image is captured. The image D2 captured by the in-vehicle camera 102 of the in-vehicle unit 100A is conceptually shown in FIG. 8B. This image D2 is attached with identification information “ID_{100A}” of the in-vehicle unit 100A, that is, the in-vehicle camera, and a timing “Ta” at which the image is captured. The images D1 and D2 having the same or substantially the same timing “Ta” are stored as images falling within the same time zone in association with each other (step S705). Accordingly, the image D2 is dealt as an image falling within the same time zone as that of the image D1 by the image analysis unit 2044 of the control unit 204 in the server device 200, and is processed as an image that supplements the image D1 of the fixed camera FC. In FIG. 8C, an image D3 captured by the in-vehicle camera 102 of an in-vehicle unit 100B of a vehicle CB at the timing “Ta” is also associated with the image D1 captured by the fixed camera FCA, the same as the image D2 captured by the in-vehicle camera 102 of the in-vehicle unit 100A. The images D1 to D3 are simultaneously stored in the storage unit 206. In other words, the image storage unit 2042 of the control unit 204 simultaneously stores the images D2 and D3 captured by the several in-vehicle cameras 102. Consequently, even if the angle of view of each in-vehicle camera 102 is narrow, it is possible to obtain a wider image by combining the captured images.

The image captured by the fixed camera FC and the image captured by the in-vehicle camera 102 may be associated with each other based on the location information. For example, when the location information of the in-vehicle camera 102 corresponds to a location within the predetermined area from the fixed camera FC, those images may be associated. This allows the images to be associated more effectively.

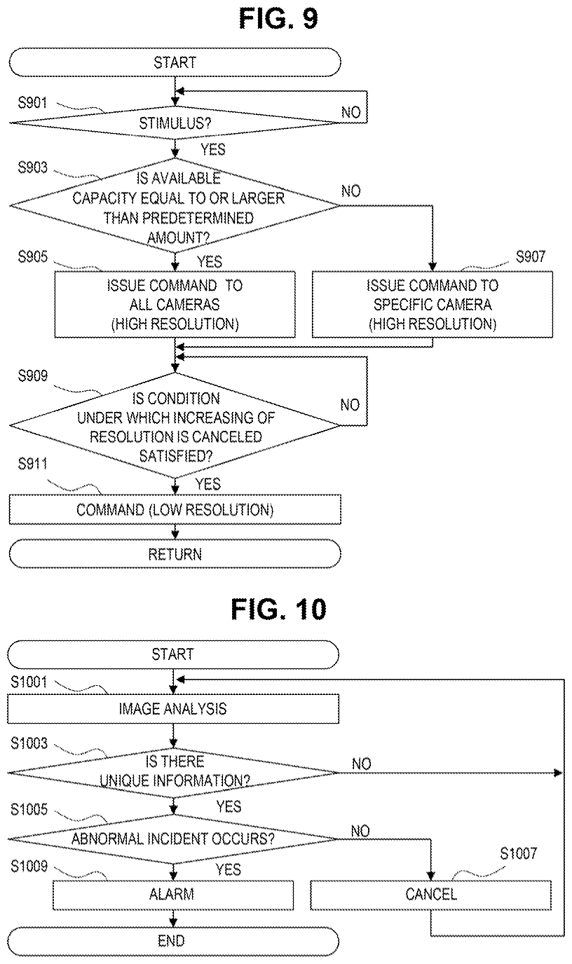

Next, a command for changing the resolution provided from the server device 200 will be described referring to FIG. 9. As shown in FIGS. 1 and 2, each of the fixed cameras FC is provided with external stimulus detection units ES (ESA, ESB, . . . ). The external stimulus detection unit ES has a configuration capable of detecting a predetermined external stimulus, for example, vibration, sound, and/or light such as infrared rays having a predetermined level or higher, and is configured as a so-called sensor. The configuration of the external stimulus detection unit ES is designed according to the detection of the external stimulus and may include one or more known sensors. The external stimulus detection unit ES is always in an on state, and when detecting the predetermined external stimulus, the external stimulus detection unit ES transmits the detected information to the server device 200. The external stimulus detection unit ES is one example of the sensor related to the fixed camera FC. The detected information on the external stimulus to be transmitted is transmitted with the identification information of the associated fixed camera FC via the communication unit of the fixed camera FC. The server device 200 can acquire the location of the detected external stimulus detection unit ES by referring to the fixed camera database 2063 of the storage unit 206 that stores the identification information and the location information of the fixed camera FC, which are associated with each other, so as to detect the external stimulus detected based on the identification information of the fixed camera FC. Accordingly, it is possible to specify a local area in which the external stimulus is detected within the target area A covered by the system S, and efficiently monitor the area.

For example, when the predetermined external stimulus is detected by an external stimulus detection unit ESA provided in the fixed camera FCA, the detected information of the external stimulus provided from the external stimulus detection unit ESA is transmitted to the server device 200 via the communication unit of the fixed camera FCA. The control unit 204 of the server device 200 detects the predetermined external stimulus by the information acquisition unit 2041 acquiring the detected information (“YES” in step S901). The information acquisition unit 2041 may acquire the detected information based on the detected foreign matter when the foreign matter is detected in the image from the fixed camera FCA and at least one image out of the images captured by the several in-vehicle cameras 102. When the foreign matter is detected in the image, it corresponds to a case where, for example, the number of pixels changes more than a reference value between consecutive frames. For example, it may be a case where a person suddenly appears in the image at a predetermined time of day, for example, at midnight, regardless of whether the vehicle enters or exits the parking lot. In addition, it may be a case where, for example, an object or a person, of which an appearance is not similar to data on an appearance of an object or a person that has been accumulated in the past, appears in the image. The detected information based on such foreign matter can be acquired even when any one of the image acquired from the fixed camera FCA or of the image acquired from the in-vehicle camera 102 has a low resolution. This is because even if the resolution is low, the foreign matter may be detected in the primary process, the resolution of the image captured by the in-vehicle camera 102 may be increased, and then detailed analysis may be carried out to make an accurate determination in the secondary process. The process of making a more accurate determination in the secondary process will be described later referring to FIG. 10.

When the predetermined external stimulus is detected, the resolution command unit 2043 of the control unit 204 acquires the available capacity of the storage unit 206 and determines whether or not the available capacity is equal to or larger than a predetermined amount (step S903). The storage unit 206 is a storage unit that stores the images captured by the in-vehicle cameras 102. The resolution command unit 2043 selects the in-vehicle camera 102 to be used for capturing the image, from among the several in-vehicle cameras 102, according to the available capacity of the storage unit 206.

When the available capacity of the storage unit 206 is equal to or larger than the predetermined amount (“YES” in step S903), the resolution command unit 2043 increases the resolution of all the in-vehicle cameras 102 in the system S to be higher than the previous resolutions. Normally, the resolution of the in-vehicle camera 102 is set to the low resolution stated above. In the present embodiment, the resolution command unit 2043 generates a command for setting the resolution of all the in-vehicle cameras 102 during the operation to the high resolution that is higher than the low resolution (step S905).

On the other hand, when the available capacity in the storage unit 206 is not equal to or larger than the predetermined amount (“NO” in step S903), the resolution command unit 2043 selects some of the in-vehicle cameras 102 in the system S. The resolution command unit 2043 increases the resolution of the selected in-vehicle cameras 102. For example, in a case shown in FIGS. 1 and 2, the shadow BSA is a shadow of the building BA and is always a blind spot of the fixed cameras FCA and FCB. On the other hand, the shadow BSB is a shadow of the vehicle stopped at the parking lot PB, and the shadow is removed when the vehicle is not stopped there. Therefore, it is the shadow BSA of the building BA that remains as the blind spot for a long time. In the present embodiment, referring to the in-vehicle unit database 2062 of the storage unit 206, for example, the in-vehicle unit 100A associated with the fixed camera FCA is selected as the in-vehicle unit 100A equipped with the in-vehicle camera 102 capable of capturing an image of the shadow BSA. Accordingly, the resolution of the in-vehicle camera 102 of the in-vehicle unit 100A is increased, and the resolution of the in-vehicle camera 102 of the in-vehicle unit 100B is not increased. That is, the in-vehicle camera 102 of the in-vehicle unit 100A is selected, and the resolution command unit 2043 generates a command for setting the resolution of such a specific in-vehicle camera 102 during the operation to the high resolution that is higher than the low resolution (step S907).

When the available capacity in the storage unit 206 is not equal to or larger than the predetermined amount (“NO” in step S903), the resolution is adjusted only for the external stimulus detection unit ES that has detected the external stimulus, that is, the in-vehicle camera 102 that is in the vicinity of the fixed camera FC should be prioritized. It is particularly effective when the target area A of the system S is as large as or larger than the predetermined area or when the area is designed in a complicated manner.

For example, it is assumed that the external stimulus detection unit ES that has detected the external stimulus is the external stimulus detection unit ESA shown in FIGS. 1 and 2. At this time, the in-vehicle camera 102 of the in-vehicle units 100A and 100B of the vehicles CA and CB shown in FIGS. 1 and 2 are identified as the in-vehicle cameras 102 around the fixed camera FCA related to the external stimulus detection unit ESA, of which the resolution is respectively increased. This is because each of the in-vehicle cameras 102 of the in-vehicle units 100A and 100B can capture the image of the area associated with the image-capturing area of the fixed camera FCA, and which, in particular, operates to cover the blind spot of the fixed camera FCA. Specifically, a command for increasing the resolution of the in-vehicle camera 102 is generated in the in-vehicle units 100A and 100B by the resolution command unit 2043 (step S907).

In step S905 or step S907, the command generated as described above is transmitted from the information providing unit 2047 to all or specific in-vehicle units 100 via the communication unit 202. This command is acquired by the information acquisition unit 1041 of each control unit 104 of the in-vehicle units 100 (step S601 in FIG. 6). Accordingly, the in-vehicle camera 102 of the in-vehicle unit 100 that has received the command captures the high resolution image, and this image is transmitted to and stored in the server device 200 as described above. At this time, in a case where the resolution of the fixed camera FCA is also adjustable, the resolution of the fixed camera FCA may be higher than the previous resolutions. A process of FIG. 9 is one example of adjusting the resolution of the acquired image of the associated area in a predetermined case.

On the other hand, the control unit 204 of the server device 200 acquires the image captured by the fixed camera FC, acquires the image captured by the in-vehicle camera 102, and executes a process of monitoring the target area. This process will be described hereinbelow referring to FIG. 10.

The image analysis unit 2044 of the control unit 204 in the server device 200 analyzes the images of the fixed camera FC and the in-vehicle camera 102 that are stored so as to be associated with each other (step S1001). For example, the image of the same area stored a predetermined amount of time ago and the latest image are compared so as to find a difference. The image analysis unit 2044 can extract unique information such as image information that has rapidly changed by at least a predetermined amount based on the difference. The image analysis (step S1001) is repeatedly executed until the unique information is extracted (as long as “NO” in step S1003).

When the unique information is extracted (“YES” in step S1003), the abnormal incident determination unit 2045 of the control unit 204 in the server device 200 compares the unique information extracted by the image analysis unit 2044 with abnormality patterns stored in advance. The abnormal incident determination unit 2045 determines whether or not an abnormal incident has occurred (step S1005). The abnormal incident determination may be carried out by the administrator of the server device 200, who visually checks the extracted unique information. Further, the determination of whether or not an abnormal incident has occurred (step S1005) is preferably carried out using the high resolution images captured at the various timings during a predetermined period. That is, as shown in FIG. 9, the determination in step S901 for detecting the predetermined external stimulus may be the primary process using the low resolution images. When the predetermined external stimulus is detected (“YES” in step S901), for example, the high resolution image is acquired from the in-vehicle camera 102, and a secondary accurate determination may be carried out in step S1005. A process of step S1005 is one example of a case where the external stimulus is detected and an incident is detected based on the image after the resolution of the image of the associated area is increased to the resolution higher than the previous resolutions.

When it is not determined that an incident has occurred (“NO” in step S1005), a cancelation flag that is usually turned off is turned on (step S1007). Meanwhile, when it is determined that an incident has occurred (“YES” in step S1005), an alarm flag, that is basically turned off, is turned on (step S1009).

When the alarm flag is turned on, the alarm unit 2046 is activated. Thereby, the alarm unit 2046 activates the alarm transmission device 210. The activation of the alarm transmission device 210 may be continuously executed for a predetermined time from a time when it is activated. Further, the activation of the alarm transmission device 210 may be terminated by a person who manages the system S, a police officer, or the like, after safety check, or after it is confirmed an abnormal incident has not occurred by those persons. When the activation of the alarm transmission device 210 is terminated, the alarm flag is turned off.

As stated above, when it is not determined that an incident has occurred (“NO” in step S1005), the cancelation flag is turned on (step S1007). In the first embodiment, the cancelation flag that is turned on is set as a condition under which the increasing of the resolution of the in-vehicle camera 102 is canceled. That is, returning to FIG. 9, the resolution of the in-vehicle camera 102 is set to the high resolution because the predetermined external stimulus is detected (steps S905 and S907), and the incident determination and/or the alarm transmission are carried out using the high resolution images as stated referring to FIG. 10. Accordingly, when it is not determined that an incident has occurred, the cancelation flag is turned on (step S1007), and it is determined that the condition under which the increasing of the resolution is canceled is satisfied (“NO” in step S909). Consequently, the process of lowering the resolution of the in-vehicle camera 102 of which the resolution has been increased is executed so as to terminate capturing the image by the in-vehicle camera 102 at the high resolution. In the present embodiment, the resolution command unit 2043 of the control unit 204 in the server device 200 generates a command for switching the resolution of the in-vehicle camera from the high resolution to the low resolution. This command is transmitted to and acquired by the in-vehicle unit 100 equipped with the in-vehicle camera 102 of which the resolution is increased (step S601 in FIG. 6). When it is determined as “YES” in step S909, the cancelation flag is turned off.

As described above, the image captured by the fixed camera FC and the image captured by the in-vehicle camera 102 are acquired in the system S according to the first embodiment. Consequently, it is possible to reliably capture an image of a wider area than in a case where only the fixed camera is provided as the camera. In the predetermined case, particularly when the predetermined external stimulus is detected, the resolution of all or selected in-vehicle cameras is increased, and the incident determination is carried out on the captured high resolution images. Consequently, the determination can be made more reliably as compared with when the in-vehicle camera has the relatively low resolution. Therefore, the ability to monitor the target area can be further enhanced.

Hereinafter, a second embodiment of the present disclosure will be described. In the second embodiment, the resolution is adjusted on the server device 200. That is, the resolution of the image acquired by the server device 200 is maintained or lowered without changing the resolution of the in-vehicle camera 102 of the in-vehicle unit 100. In the following description, only the differences between the second embodiment and the first embodiment will be described.

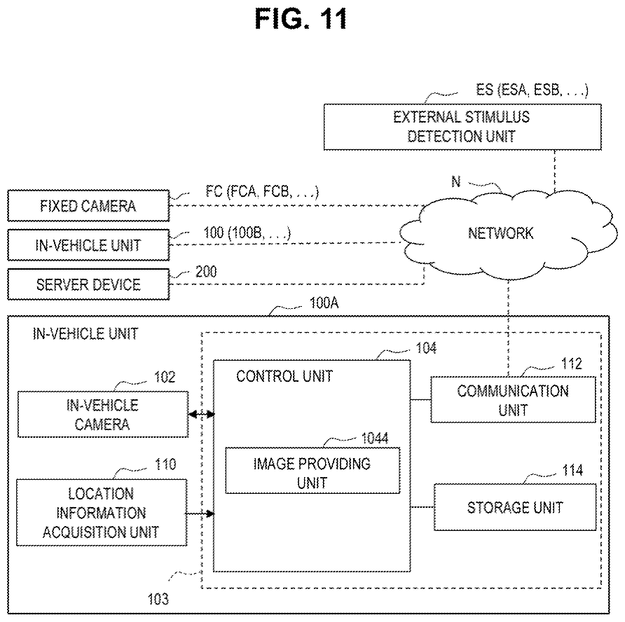

FIG. 11 shows a block diagram of the configuration of the in-vehicle unit 100A. The control unit 104 of the in-vehicle unit 100A has the image providing unit 1044 of FIG. 3 described above as a control module, but does not have the information acquisition unit 1041, the mode switching unit 1042, and the resolution adjustment unit 1043. Therefore, when the in-vehicle unit 100A is in the predetermined area, the image providing unit 1044 captures the image and transmits the image to the server device 200 as described referring to FIG. 5. The image provided at this time is the high resolution image.

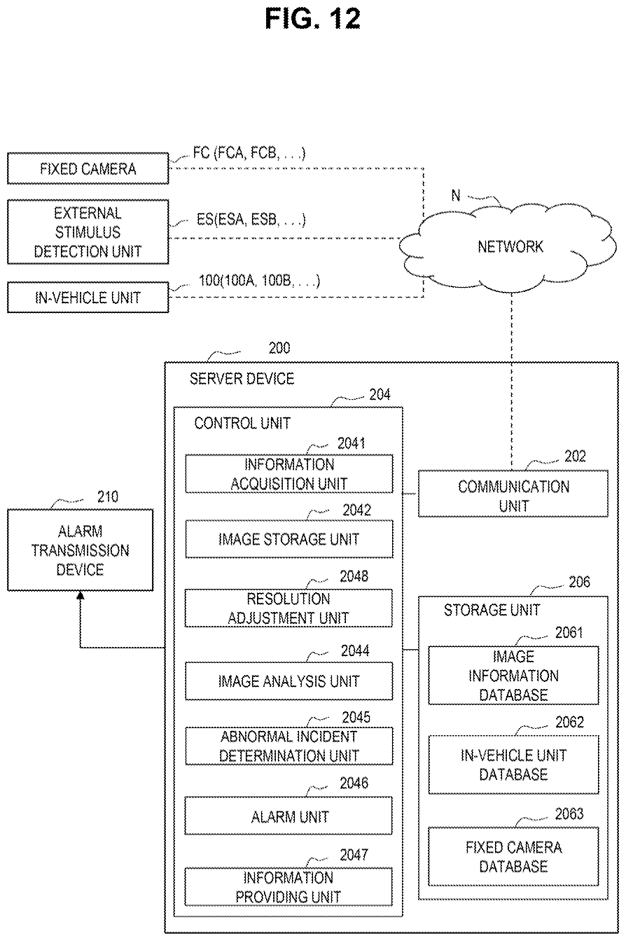

As shown in FIG. 12, the control unit 204 of the server device 200 has a resolution adjustment unit 2048 as a functional module instead of the resolution command unit 2043. The resolution adjustment unit 2048 lowers the resolution of the acquired image, which is captured by the in-vehicle camera 102, in the predetermined case, i.e., when the predetermined external stimulus is not included, and transmits the image with the lowered resolution to the image storage unit 2042. Accordingly, the low resolution image is stored as the image of the in-vehicle camera 102. This image with the lowered resolution corresponds to the low resolution image stated above.

On the other hand, the resolution adjustment unit 2048 of the control unit 204 in the server device 200 stops the process of lowering the resolution when the predetermined external stimulus is detected. The process of lowering the resolution may be stopped for all the images captured by all the in-vehicle cameras 102, or, for example, only the image transmitted from the specific in-vehicle camera 102 related to the detection of the external stimulus.

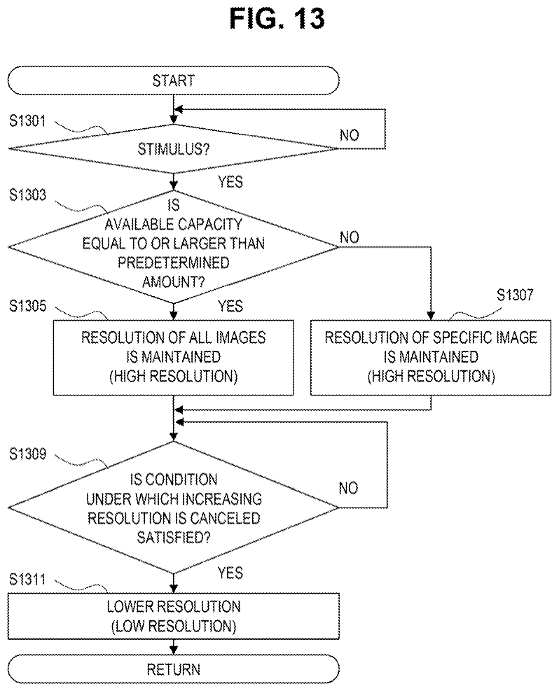

Such a resolution adjustment process will be described referring to FIG. 13. When the predetermined external stimulus is not detected (“NO” in step S1301), the resolution of the image captured by the in-vehicle camera 102 is adjusted to be lowered according to the basic settings. Step S1301 corresponds to step S901 in FIG. 9.

When the predetermined external stimulus is detected (“YES” in step S1301), the resolution adjustment unit 2048 acquires the available capacity in the storage unit 206 in the same manner as that in step S903 of FIG. 9, and determines whether or not the available capacity is equal to or larger than the predetermined amount (step S1303). When the available capacity of the storage unit 206 is equal to or larger than the predetermined amount (“YES” in step S1303), the resolution of all the images captured by the in-vehicle cameras 102 are maintained without being decreased (step S1305). Accordingly, all of these images are stored in the high resolution, and the image analysis is carried out.

On the other hand, when the predetermined external stimulus is detected (“YES” in step S1301) and the available capacity of the storage unit 206 is not equal to or larger than the predetermined amount (“NO” in step S1303), some of the in-vehicle cameras 102, that is, the images captured by those in-vehicle cameras, are selected. This selection is carried out in the same manner as that of the in-vehicle camera 102 in step S907 of FIG. 9. The resolution of only the image of the selected in-vehicle camera 102 is maintained at the high resolution without being decreased (step S1307).

When it is determined in step S1309 corresponding to step S909 in FIG. 9 that the condition under which the increasing of the resolution is canceled is satisfied, those images are not maintained at the high resolution any more, and the resolutions of those images are adjusted so as to decrease the resolution (Step S1311).

As described above, in the second embodiment of the present disclosure, the control unit 204 of the server device 200 respectively acquires the image captured by the fixed camera FC and the image captured by the in-vehicle camera 102, and stores them in association with each other. The resolution of the image captured by the in-vehicle camera 102 is adjusted by the server device 200. When it is not the predetermined case, the resolution of the image captured by the in-vehicle camera 102 is adjusted to the low resolution which is lower than the resolution when the image has been captured. In the predetermined case, the resolution of the image captured by the in-vehicle camera 102 is maintained at the resolution higher than the low resolution, that is, the high resolution. Therefore, in the system of the second embodiment, it is also possible to reliably capture an image of a wider area and further enhance the ability to monitor the target area, similar to the system S of the first embodiment.

In the first and second embodiments described above, the predetermined case is a case where the predetermined external stimulus is detected, but the predetermined case is not limited thereto. For example, the predetermined case can be set to adapt to the service of monitoring elderly persons. For example, a condition under which the elderly person does not respond to a mobile terminal held by him/her may be the condition in the predetermined case.

Further, in the first and second embodiments stated above, the vehicle is a vehicle parked in the parking lot PA or PB, but the vehicle may pass therethrough. For example, when the vehicle CA leaves the parking lot PA, another vehicle CC may stop in the parking lot PA. In this case, the in-vehicle camera 102 of the vehicle CC may be incorporated into and used with the system.

The embodiments stated above are mere examples, and the present disclosure can be implemented with appropriate modifications within a scope not departing from the gist thereof. The processes and/or units described in the present disclosure can be partly taken out and implemented, or alternatively, freely combined and implemented unless technical contradiction occurs.

The processes described as being performed by a single device may be executed in a shared manner by a plurality of devices. For example, the server device 200 corresponding to the information processing apparatus does not need to be a single computer, and may be configured as a system including several computers. Alternatively, the processes described as being performed by different devices may be executed by a single device. In the computer system, the hardware configuration for implementing each function can be flexibly changed.

The present disclosure can also be implemented by supplying a computer program for executing the functions described in the embodiments in a computer, and reading and executing the program by one or more processors included in the computer. Such a computer program may be provided to the computer by a non-transitory computer-readable storage medium connectable to a computer system bus, or may be provided to the computer via the network. Examples of the non-transitory computer-readable storage media include random disk (such as a magnetic disk (floppy (registered trademark) disk, hard disk drive (HDD), and the like) or optical disc (CD-ROM, DVD disc, Blu-ray disc, and the like)), read-only memory (ROM), random access memory (RAM), EPROM, EEPROM, magnetic card, flash memory, optical card, and a random type of medium suitable for storing electronic instructions.

What is claimed is:

1. An information processing apparatus comprising:
a control unit configured to:
acquire an image captured by a fixed camera;
acquire, from an in-vehicle camera, an image of an area associated with an image-capturing area of the fixed camera; and
adjust, in a predetermined case, a resolution of the acquired image of the associated area.

2. The information processing apparatus according to claim 1, wherein the adjusting of the resolution of the image of the associated area includes adjusting at least one of a resolution of the in-vehicle camera when capturing the image and a resolution of the image captured by the in-vehicle camera.

3. The information processing apparatus according to claim 1, wherein the control unit is configured to store the image captured by the fixed camera in association with the image of the associated area captured by the in-vehicle camera.

4. The information processing apparatus according to claim 1, wherein the adjusting of the resolution further includes increasing the resolution of the in-vehicle camera to a resolution higher than previous resolutions when detecting at least one of external stimulus in the image captured by the fixed camera, external stimulus in the image of the associated area captured by the in-vehicle camera, and external stimulus input from a sensor associated with the fixed camera.

5. The information processing apparatus according to claim 4, wherein the control unit is configured to detect the external stimulus and detect an abnormal incident based on an image after the resolution of the image of the associated area is increased to the resolution higher than the previous resolutions.

6. The information processing apparatus according to claim 3, wherein the control unit is configured to simultaneously store images captured by a plurality of in-vehicle cameras.

7. The information processing apparatus according to claim 1, wherein the control unit is configured to select an in-vehicle camera to be used for capturing the image, out of a plurality of in-vehicle cameras, according to an available capacity of a storage unit in which images captured by the plurality of in-vehicle cameras are stored.

8. The information processing apparatus according to claim 1, wherein the control unit is configured to associate the fixed camera with the in-vehicle camera when a vehicle equipped with the in-vehicle camera is parked at a predetermined location with respect to the fixed camera.

9. An information processing method executed by at least one computer, the information processing method comprising:
acquiring an image captured by a fixed camera;
acquiring, from an in-vehicle camera, an image of an area associated with an image-capturing area of the fixed camera; and
adjusting, in a predetermined case, a resolution of the acquired image of the associated area.

10. The information processing method according to claim 9, wherein the adjusting of the resolution of the image of the associated area includes adjusting at least one of a resolution of the in-vehicle camera when capturing the image and a resolution of the image captured by the in-vehicle camera.

11. The information processing method according to claim 9, further comprising storing the image captured by the fixed camera in association with the image of the associated area captured by the in-vehicle camera.

12. The information processing method according to claim 9, wherein the adjusting of the resolution further includes increasing the resolution of the in-vehicle camera to a resolution higher than previous resolutions when detecting at least one of external stimulus in the image captured by the fixed camera, external stimulus in the image of the associated area captured by the in-vehicle camera, and external stimulus input from a sensor associated with the fixed camera.

13. The information processing method according to claim 12, further comprising:
detecting the external stimulus; and
detecting an abnormal incident based on an image after the resolution of the image of the associated area is increased to the resolution higher than the previous resolutions.

14. The information processing method according to claim 11, further comprising simultaneously storing images captured by a plurality of in-vehicle cameras.

15. The information processing method according to claim 9, further comprising selecting an in-vehicle camera to be used for capturing the image, out of a plurality of in-vehicle cameras, according to an available capacity of a storage unit in which images captured by the plurality of in-vehicle cameras are stored.

16. The information processing method according to claim 9, further comprising associating the fixed camera with the in-vehicle camera when a vehicle equipped with the in-vehicle camera is parked at a predetermined location with respect to the fixed camera.

17. A system comprising:
a fixed camera; and
an information processing apparatus that cooperates with an in-vehicle camera, wherein the information processing apparatus includes a control unit configured to:
acquire an image captured by the fixed camera;
acquire, from the in-vehicle camera, an image of an area associated with an image-capturing area of the fixed camera; and
adjust, in a predetermined case, a resolution of the acquired image of the associated area.

18. The system according to claim 17, wherein the adjusting of the resolution of the image of the associated area includes adjusting at least one of a resolution of the in-vehicle camera when capturing the image and a resolution of the image captured by the in-vehicle camera.

19. The system according to claim 17, wherein the control unit is configured to store the image captured by the fixed camera in association with the image of the associated area captured by the in-vehicle camera.

20. The system according to claim 17, wherein the adjusting of the resolution further includes increasing the resolution of the in-vehicle camera to a resolution higher than previous resolutions when detecting at least one of external stimulus in the image captured by the fixed camera, external stimulus in the image of the associated area captured by the in-vehicle camera, and external stimulus input from a sensor associated with the fixed camera.
